(19) United States
(12) Patent Application Publication
(10) Pub. No.: US 2026/0112757 A1
(43) Pub. Date: Apr. 23, 2026

(54) APPARATUS AND METHOD FOR ASSEMBLING BATTERY FOR VEHICLE

(71) Applicants: Hyundai Motor Company, Seoul (KR); Kia Corporation, Seoul (KR)

(72) Inventors: Jun Hyeok Bae, Hwaseong (KR); Yun Su Jeong, Hwaseong (KR); Young Seok Lee, Hwaseong (KR); Jong Min Park, Hwaseong (KR)

(21) Appl. No.: 19/310,585

(22) Filed: Aug. 26, 2025

(30) Foreign Application Priority Data
Oct. 18, 2024 (KR) 10-2024-0143373
Apr. 15, 2025 (KR) 10-2025-0048683

(51) Int. Cl. H01M 50/258; H01M 50/204; H01M 50/262

(52) U.S. Cl. CPC H01M 50/258; H01M 50/204; H01M 50/262; H01M 2220/20

(57) ABSTRACT

An apparatus and method for assembling a battery are used to assemble the battery for a vehicle such as an electric vehicle or a hybrid vehicle. The apparatus may include a plurality of battery cells stacked on one another. In the apparatus, a first end plate and a second end plate are brought into close contact with opposite sides of the stacked battery cells, and may be disposed between a pair of adapter plates. The first and second end plates are assembled into a battery module assembly (BMA) using the pair of adapter plates that can move forward or rearward by a bolt fastening method, allowing the battery cells to be fastened with a constant and even surface pressure. A base pallet is made to be commonly used when assembling various types of BMAs, in order to reduce the number of assembly processes.

### CROSS-REFERENCE TO RELATED APPLICATIONS

This application claims under 35 U.S.C. § 119(a) the benefit of Korean Patent Application No. 10-2024-0143373 filed on Oct. 18, 2024, and Korean Patent Application No. 10-2025-0048683 filed on Apr. 15, 2025, the entire contents of which are incorporated herein by reference.

### BACKGROUND

### (a) Technical Field

The present disclosure relates to an apparatus and method for assembling a battery for a vehicle, more particularly, to the apparatus and method configured to assemble a battery module assembly.

### (b) Description of the Related Art

A battery module assembly (BMA) mounted in an electric vehicle, a hybrid vehicle, an energy storage system, and the like, may include a plurality of battery cells stacked on one another. In the BMA, a first end plate and a second end plate may protect the stacked battery cells by being brought into close contact with opposite surfaces of the stacked battery cells, respectively, and a clamp may press the stacked battery cells with a predetermined fastening surface pressure by being connected between the first end plate and the second end plate.

In order to prevent a swelling phenomenon in which the battery cell swells due to a pressure created when the lithium ion electrolyte in the battery cell evaporates, the plurality of battery cells included in the BMA must be fastened with a predetermined surface pressure.

To this end, an apparatus for assembling a battery of a related art includes a first pressure block mounted on a base pallet, a second pressure block arranged on the base pallet in a forwardly and rearwardly movable manner, a slide configured to guide the forward and rearward movement of the second pressure block, and a spring configured to exert an elastic restoring force to move the second pressure block back to its original position when the second pressure block is moved forward.

The stacked battery cells, and the first end plate and the second end plate brought into close contact with the opposite surfaces of the stacked battery cells, respectively, are disposed between the first pressure block and the second pressure block, and then the second pressure block is moved forward at a predetermined distance, allowing the first end plate and the second end plate to press the battery cells with a predetermined surface pressure.

Next, the first end plate is connected to the second end plate with the clamp, completing a first-stage assembly of the BMA.

Afterwards, the base pallet on which the BMA, which has completed the first-stage assembly, is mounted is transported to a post-assembly process (post-assembly process for assembling other components) by a transport conveyor.

However, the apparatus for assembling the battery of the related art has the following problems.

First, only one type of BMA including battery cells of identical sizes, etc., may be assembled and transported to a subsequent process, and assembly and transport of different types of BMAs including battery cells of different sizes, etc., are impossible.

Second, the base pallet is only used in the assembly process and the transport to a post-assembly process for one type of BMA and cannot be commonly used when assembling different types of BMAs, causing an increase in the number of assembly processes and assembly costs.

Third, when the BMA is assembled, that is, when a predetermined surface pressure is applied to the first end plate and the second end plate by the second pressure block, the battery cells are not fastened with a constant and even surface pressure due to the elastic restoring force of the spring, and accordingly, a reassembly process for reassembling the BMA is additionally performed.

The above information disclosed in this Background section is only for enhancement of understanding of the background of the present disclosure, and therefore it may contain information that does not form the related art that is already known to a person having ordinary skill in the art.

### SUMMARY

The present disclosure provides an apparatus for assembling a battery, wherein the apparatus has a structure in which a plurality of battery cells stacked on one another, and a first end plate and a second end plate brought into close contact with opposite sides of the stacked battery cells, respectively, are disposed between a pair of adapter plates, and then are assembled into a battery module assembly (BMA) using the pair of adapter plates forwardly and rearwardly moving by a bolt fastening method, allowing the battery cells to be fastened with a constant and even surface pressure, and moreover, a base pallet is made to be commonly used when assembling various types of BMAs, reducing the number of assembly processes, assembly costs and the like.

According to the present disclosure, an apparatus for assembling a battery includes: a first adapter plate, wherein at least two guide shafts are mounted on the first adapter plate; a second adapter plate, wherein a guide cylinder into which the guide shaft is inserted is mounted on the second adapter plate; a biasing member fitted onto the guide shaft and configured to be engaged by the guide cylinder in response to the second adapter plate moving forward; and an engagement member associated with the guide shaft.

In an aspect, the present disclosure provides an apparatus for assembling a battery, wherein the apparatus includes a first adapter plate, wherein at least two or more guide shafts are mounted on an inner surface of the first adapter plate, a second adapter plate, wherein a guide cylinder into which the guide shaft is inserted is mounted on an inner surface of the second adapter plate, a spring fitted onto the guide shaft and configured to be pressed by the guide cylinder in response to the second adapter plate moving forward, and a bolt inserted and fastened into the guide shaft from an outer surface of the second adapter plate.

In an embodiment, the first adapter plate and the second adapter plate each may have a structure in which a pair of pressure plates configured to press a plurality of battery cells stacked on one another is integrally connected to each other by a connection plate.

In another embodiment, the pressure plate may have an inner surface on which a pair of pressure blocks configured to press the stacked battery cells with a predetermined surface pressure is mounted by being brought into contact with each of opposite surfaces of the stacked battery cells.

In another embodiment, the pressure plate may have an inner surface on which a position limiting pin configured to restrict a position of the stacked battery cells is mounted by being brought into close contact with each of a first end plate and a second end plate stacked on opposite surfaces of the stacked battery cells, respectively.

In another embodiment, a support block configured to support a bottom surface of the stacked battery cells may be mounted at an outer position from a lower inner surface of the pressure plate.

In another embodiment, a rigidity reinforcement bracket configured to reinforce a rigidity of each of the first adapter plate and the second adapter plate may be mounted on an outer surface portion of the connection plate connected between the pair of pressure plates.

In another embodiment, the rigidity reinforcement bracket may have opposite end portions extending to the pair of pressure plates, respectively, to serve as a support (e.g., a washer) for the engagement member, which may be a bolt.

In another embodiment, the guide cylinder may have an internal portion formed with a first hollow hole into which the guide shaft is inserted, and with a second hollow hole having a larger diameter than the first hollow hole to support the biasing member inserted into the second hollow hole.

In another embodiment, the guide shaft may have an end portion formed with a female screw hole into which the engagement member is inserted and fastened.

In another embodiment, a plurality of battery cells stacked on one another, and a first end plate and a second end plate brought into close contact with opposite sides of the stacked battery cells, respectively, may be disposed in a pressing manner between the first adapter plate and the second adapter plate.

In another embodiment, by a pressing motion in which the second adapter plate is moved forward in a state where the first adapter plate is fixed and a motion in which the engagement member (e.g., bolt) is fastened into the guide shaft from the outer surface of the second adapter plate, a surface pressure to assemble the stacked battery cells, the first end plate and the second end plate into a battery module assembly may be applied to the stacked battery cells, the first end plate and the second end plate.

In another embodiment, by connecting a clamp or a fastening bolt into an assembly hole formed in each of the first end plate and the second end plate, the stacked battery cells, the first end plate and the second end plate may be assembled into a battery module assembly.

In another embodiment, the apparatus may further include a base pallet on which the first adapter plate and the second adapter plate are mounted to be transported for a post-process.

In another embodiment, a plurality of support protrusions on which the first adapter plate and the second adapter plate are seated may be formed on an upper surface portion of the base pallet, and a fixation pin may be formed on an upper surface portion of some of the support protrusions.

In another embodiment, a bush into which the fixation pin of the support protrusion is inserted may be attached to a lower surface of each of the first adapter plate and the second adapter plate.

In another embodiment, the plurality of support protrusions may be formed on the upper surface portion of the base pallet in an arrangement in which the first adapter plate and the second adapter plate of different sizes for assembling battery assemblies of different specifications are seated.

The battery may be mounted in a vehicle such as an electric vehicle, a hybrid vehicle, etc.

According to the present disclosure, a method for assembling a battery includes steps of: mounting at least two guide shafts on a first adapter plate; mounting a guide cylinder on a second adapter plate, and inserting a guide shaft into the guide cylinder; engaging, by the guide cylinder, a biasing member fitted onto the guide shaft in response to the second adapter plate moving forward; and providing an engagement member associated with the guide shaft, e.g., inserting the engagement member into the guide shaft.

Other aspects and embodiments of the present disclosure are discussed infra.

### BRIEF DESCRIPTION OF THE DRAWINGS

The above and other features of the present disclosure will now be described in detail with reference to various embodiments thereof illustrated in the accompanying drawings which are given herein below by way of illustration only, and thus are not limitative of the present disclosure, and wherein:

FIG. 1 is a perspective view illustrating an apparatus for assembling a battery according to the present disclosure;

FIG. 2 is a bottom view illustrating a state in which battery cells stacked on one another are disposed between a first adapter plate and a second adapter plate of an apparatus for assembling a battery according to the present disclosure;

FIG. 3 is a bottom view illustrating a motion of a second adapter plate of an apparatus for assembling a battery according to the present disclosure moving forward to press battery cells;

FIG. 4 is a bottom view illustrating a motion of an engagement member being fastened from a second adapter plate of an apparatus for assembling a battery according to the present disclosure to a guide shaft;

FIG. 5 is a side view illustrating a state in which battery cells stacked on one another are pressed with a predetermined fastening surface pressure by a first adapter plate and a second adapter plate of an apparatus for assembling a battery according to the present disclosure;

FIG. 6 is a cross-sectional view illustrating an internal structure of a guide shaft and a guide cylinder of an apparatus for assembling a battery according to the present disclosure;

FIG. 7 is a perspective view illustrating a state in which battery cells stacked on one another that have been pressed with a predetermined fastening surface pressure by a first adapter plate and a second adapter plate of an apparatus for assembling a battery according to the present disclosure are being fastened using fastening bolts;

FIGS. 8 and 9 are perspective and cross-sectional views illustrating a state in which a first adapter plate and a second adapter plate of an apparatus for assembling a battery according to the present disclosure are being mounted on a base pallet to be transported for a post-process; and

FIGS. 10 and 11 are perspective and cross-sectional views illustrating a state in which a first adapter plate and a second adapter plate configured to assemble battery assemblies of different specifications are being mounted on a base pallet of an apparatus for assembling a battery according to the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited by the terms. These terms are only used to distinguish one component from another. For example, a first component could be termed a second component, and similarly, a second component could be termed a first component, without departing from the scope of various embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for the purpose of illustrating embodiments and is not intended to limit the present disclosure. In this specification, the singular form includes plural forms unless specified otherwise.

Hereinafter, various embodiments of the present disclosure are described in detail with reference to the attached drawings.

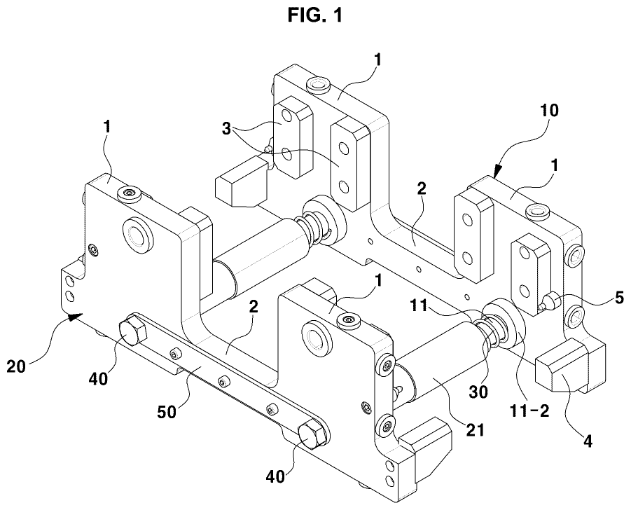

FIG. 1 is a perspective view illustrating an apparatus for assembling a battery according to the present disclosure, and FIG. 6 is a cross-sectional view illustrating an internal structure of a guide shaft and a guide cylinder of an apparatus for assembling a battery according to the present disclosure.

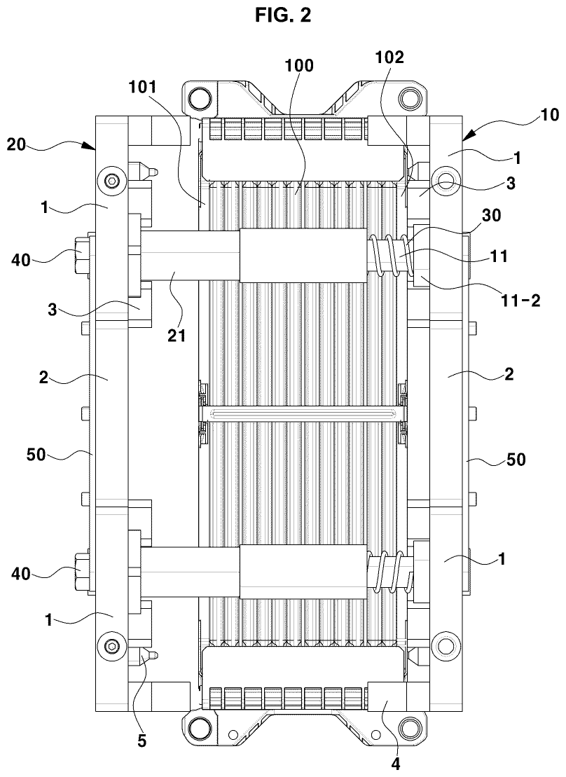

As illustrated in FIG. 1 and FIG. 2, a first adapter plate 10 and a second adapter plate 20 each has a structure in which a pair of pressure plates 1 configured to actually press battery cells 100 is integrally connected to each other by a connection plate 2.

At least two guide shafts 11 configured to guide the forward and rearward movement of the second adapter plate 20 in a straight line are mounted on an inner surface of the first adapter plate 10.

Here, a guide shaft 11 may be mounted on a lower inner surface of each of the pressure plates 1 of the first adapter plate 10.

A guide cylinder 21 into which the guide shaft 11 of the first adapter plate 10 is inserted is mounted on an inner surface of the second adapter plate 20.

Here, a hollow guide cylinder 21 into which the guide shaft 11 of the first adapter plate 10 is inserted may be mounted at a lower inner surface of each of the pressure plates 1 of the second adapter plate 20.

Referring to FIG. 6, because a biasing member (e.g., a spring member, or spring) 30 is fitted onto an external circumferential surface of the guide shaft 11 before the guide shaft 11 of the first adapter plate 10 is inserted into the guide cylinder 21 of the second adapter plate 20, the biasing member 30 is pressed by the guide cylinder 21 when the second adapter plate is moved forward.

To this end, the guide cylinder 21 has an internal portion formed with a first hollow hole 21-1 into which the guide shaft 11 is inserted, and with a second hollow hole 21-2 having a larger diameter than the first hollow hole 21-1 so as to elastically support the biasing member 30 inserted into the second hollow hole 21-2.

Accordingly, the biasing member 30 fitted onto the external circumferential surface of the guide shaft 11 and inserted into the second hollow hole 21-2 in the guide cylinder 21 may be disposed in a pressing manner between a stopper surface 21-3 defined at an internal end portion of the second hollow hole 21-2 and a head portion 11-2 of the guide shaft 11.

Moreover, a female screw hole 11-1 may be formed at an end portion of the guide shaft 11, and an engagement member (e.g., a bolt) 40 inserted from an outer surface of the second adapter plate 20 may be fastened into the female screw hole 11-1 in the guide shaft 11. As provided herein, the engagement member 40 may be a bolt, screw, clasp, locking mechanism, nut, washer, anchor, or the like.

Therefore, when the second adapter plate 20 is moved forward in a state where the first adapter plate 10 is fixed, a motion in which the guide cylinder 21 is moved forward to press the biasing member 30 and a motion in which the engagement member 40 that has protruded outwardly after the second adapter plate 20 was moved forward is inserted and fastened into the female screw hole 11-1 in the guide shaft 11 may be performed.

Meanwhile, a rigidity reinforcement bracket 50 for reinforcing a rigidity is mounted on an outer surface of the connection plate 2, which constitutes each of the first adapter plate 10 and the second adapter plate 20, by being brought into close contact with the outer surface of the connection plate 2, and opposite end portions of the rigidity reinforcement bracket extend to the pair of pressure plates 1, respectively.

Accordingly, the rigidity reinforcement bracket 50 may serve to reinforce the rigidity of the first adapter plate 10 and the second adapter plate 20 to prevent distortion or deformation of the first adapter plate 10 and the second adapter plate 20, and the opposite end portions of the rigidity reinforcement bracket 50 each may serve as a washer to which the head portion of the engagement member 40 is pressed against when the engagement member 40 as described above is fastened.

Referring to FIGS. 2 to 5, the plurality of battery cells 100 stacked on one another, and a first end plate 101 and a second end plate 102 brought into close contact with opposite surfaces of the stacked battery cells 100, respectively, to protect the battery cells 100 are disposed between the first adapter plate 10 and the second adapter plate 20 in a pressing and positionally limitable manner.

To this end, a support block 4 configured to support a bottom surface portion of the stacked battery cells 100 is mounted at an outer position from the lower inner surface of the pressure plate 1.

Moreover, a pair of pressure blocks 3 configured to press the stacked battery cells 100 with a predetermined surface pressure is mounted on each of the pressure plates 1 of the first end plate 101 and on each of the pressure plates 1 of the second end plate 102 by being brought into contact with the first end plate 101 and the second end plate 102 stacked on the opposite surfaces of the stacked battery cells 100, respectively.

For example, in order to prevent contact damage, and the like, caused by the pressure plate 1, which may be made of a metal material, pressing the first end plate 101 and the second end plate 102 stacked on the opposite surfaces of the stacked battery cells 100, respectively, the pressure block 3, which may be made of a rubber material, is mounted on the inner surface of the pressure plate 1 to actually press the first end plate 101 and the second end plate 102 stacked on the opposite surfaces of the stacked battery cells 100, respectively, protecting the first end plate 101 and the second end plate 102, as well as the battery cells 100, from damage.

Furthermore, a position limiting pin 5 configured to limit the position of the stacked battery cells 100 is mounted on the inner surface of the pressure plate 1 by being brought into close contact with each of the first end plate 101 and the second end plate 102 stacked on the opposite surfaces of the stacked battery cells 100, respectively.

Here, a process of assembling a battery module assembly (BMA) using the apparatus for assembling the battery according to the disclosed embodiment is as follows.

First, as illustrated in FIG. 2, the plurality of battery cells 100 stacked on one another, and the first end plate 101 and the second end plate 102 brought into close contact with the opposite surfaces of the stacked battery cells 100, respectively, are disposed in a pressing manner between the first adapter plate 10 and the second adapter plate 20.

Here, the bottom surface portion of the battery cells 100 is supported on the support block 4 formed at the outer position from the lower inner surface of the pressure plate 1.

Next, a pressing motion in which the second adapter plate 20 is moved forward in the state where the first adapter plate 10 is fixed is performed.

For example, the second adapter plate 20 is pushed in a state where the first adapter plate 10 is held by a robot, allowing the second adapter plate 20 to move toward the stacked battery cells 100.

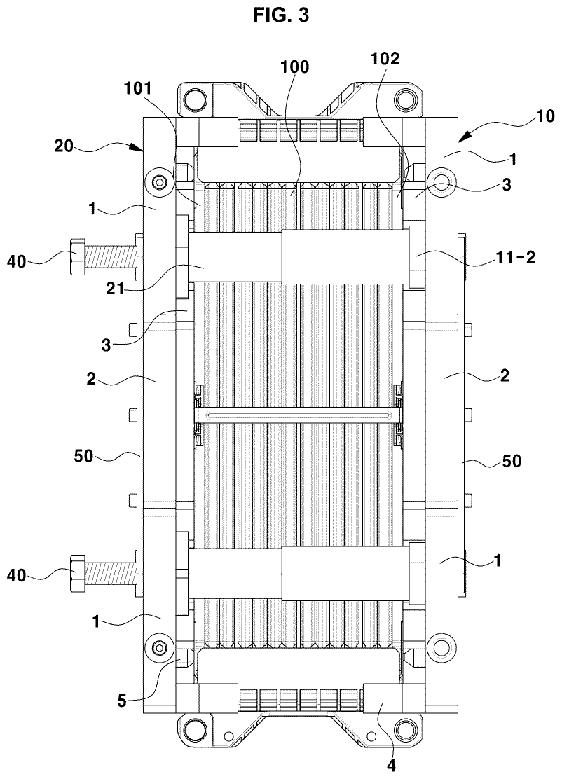

Accordingly, as illustrated in FIG. 3, as the second adapter plate 20 is moved forward, and at the same time the pressure block 3 mounted on the inner surface of the second adapter plate 20 is moved forward to actually press the battery cells 100, the battery cells 100 may be brought into close contact with one another with a predetermined surface pressure that prevents swelling of the battery cells 100.

More specifically, because the pressure block 3 of the second adapter plate 20 presses the first end plate 101 stacked on one surface of the stacked battery cells 100, and at the same time the pressure block 3 of the first adapter plate 10 supports the second end plate 102 stacked on another surface of the stacked battery cells 100, a predetermined fastening surface pressure to prevent the swelling phenomenon is applied on the stacked battery cells 100 disposed between the first end plate 101 and the second end plate 102, and accordingly, the battery cells 100 may be brought into close contact with one another to prevent the swelling phenomenon.

Here, after the second adapter plate 20 is moved forward in the state where the first adapter plate 10 is fixed and at the same time the guide cylinder 21 is moved forward to press the biasing member 30, the head portion of the engagement member 40 and a portion of the length of the engagement member 40 are kept outwardly protruded, as illustrated in FIG. 3.

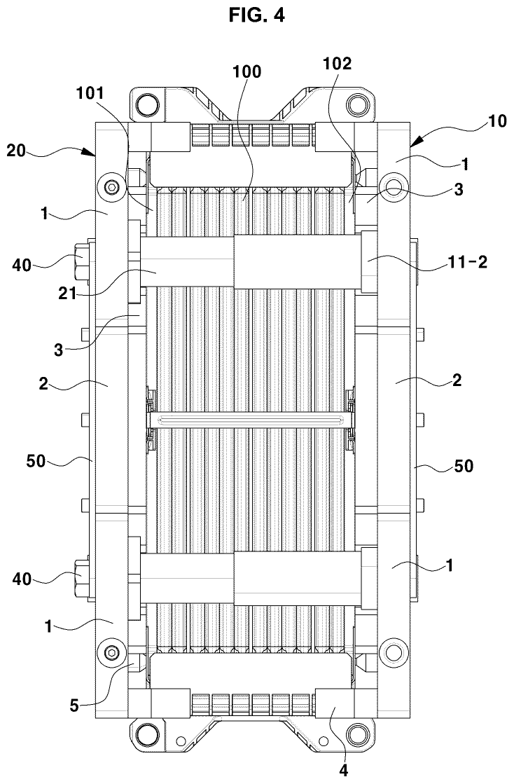

Thereafter, as illustrated in FIG. 4, a motion of inserting and fastening the engagement member 40 into the female screw hole 11-1 in the guide shaft 11 is performed.

In further detail, by the motion of fastening the engagement member 40 from the outer surface of the second adapter plate 20 into the female screw hole 11-1 in the guide shaft 11, the surface pressure applied to the first end plate 101, the stacked battery cells 100 and the second end plate 102, that is, the predetermined fastening surface pressure for preventing the swelling phenomenon of the battery cells 100 may be kept constant, and accordingly, the battery cells 100 may be kept being in close contact with one another in a manner to prevent the swelling phenomenon.

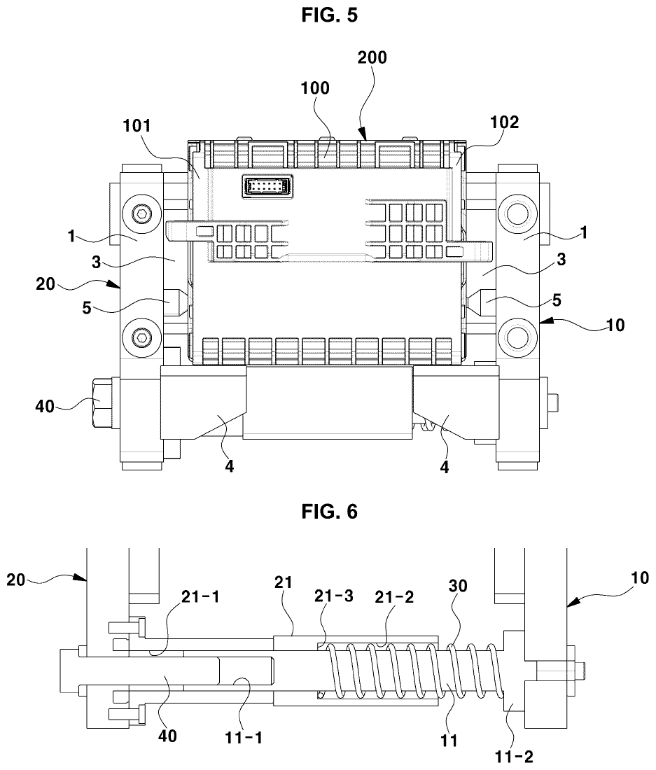

Here, as illustrated in FIG. 5, the position limiting pin 5 mounted on the inner surface of the pressure plate 1 is brought into close contact with each of the first end plate 101 and the second end plate 102 stacked on the opposite surfaces of the stacked battery cells 100, respectively, preventing the first end plate 101 and the second end plate 102, as well as the stacked battery cells 100, from being deviated from respective positions.

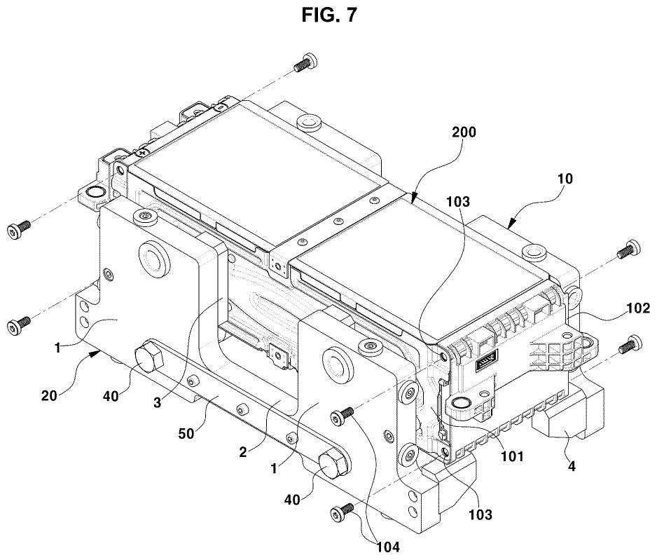

Next, as illustrated in FIG. 7, structures, such as a housing, are attached to cover the first end plate 101 and the second end plate 102, as well as the stacked battery cells 100, and then a clamp or a fastening bolt 104 is connected to an assembly hole 103 formed in each of the first end plate 101 and the second end plate 102, assembling the stacked battery cells 100, the first end plate 101 and the second end plate 102 into a single BMA 200.

As such, the BMA may be easily assembled by the simple motion of pressing the second adapter plate forward in the state where the first adapter plate 10 is fixed and the motion of fastening the second adapter plate 20 to the first adapter plate 10 with engagement members (e.g., bolts), allowing the battery cells 100 to be fastened with a constant and even surface pressure, and reducing the number of assembly processes and the cost of assembly compared to the spring-based assembly method of the related art.

Meanwhile, the apparatus for assembling the battery according to the disclosed embodiment may further include a base pallet 60 on which the first adapter plate 10 and the second adapter plate 20 are mounted to transport the BMA for a post-assembly process, that is, to transport the BMA to a post-assembly process for assembling other components to the BMA.

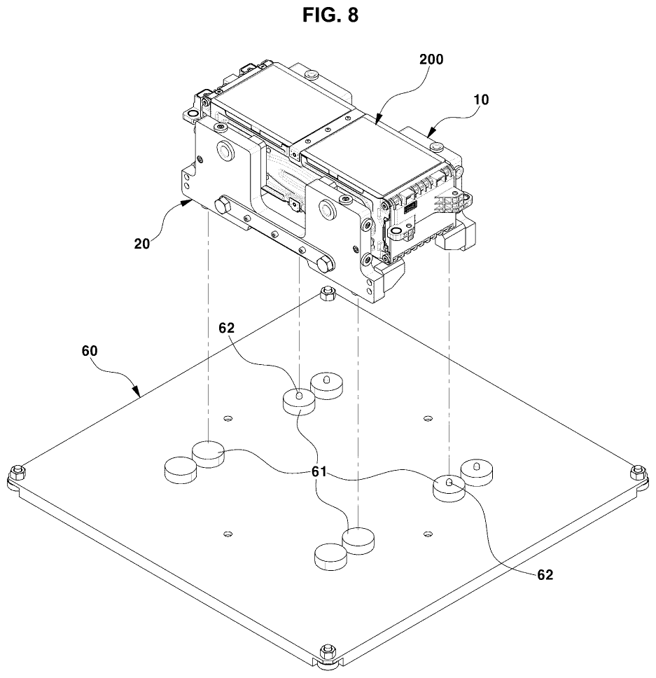

To this end, the base pallet 60 may be, as illustrated in FIG. 8, implemented as a rectangular plate having a predetermined area, wherein a plurality of support protrusions 61 on which the first adapter plate 10 and the second adapter plate 20 are mounted is formed on an upper surface portion of the base pallet 60.

Moreover, a fixation pin 62 is formed to protrude on an upper surface portion of some of the plurality of support protrusions 61.

Furthermore, a bush 6 into which the fixation pin 62 of the support protrusion 61 is inserted is mounted on a bottom surface of each of the first adapter plate 10 and the second adapter plate 20.

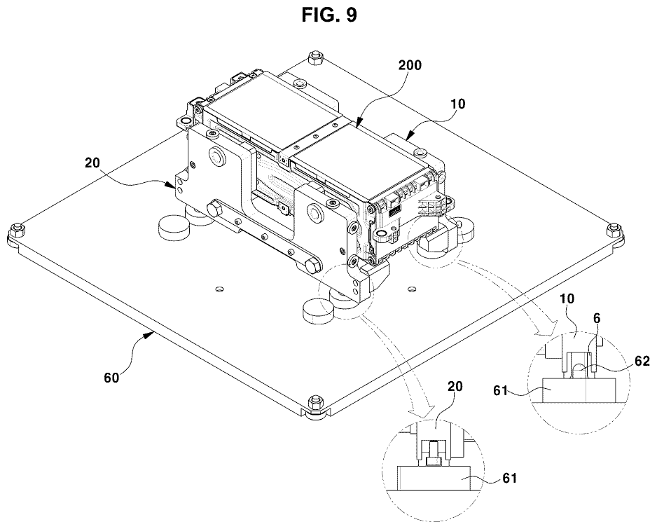

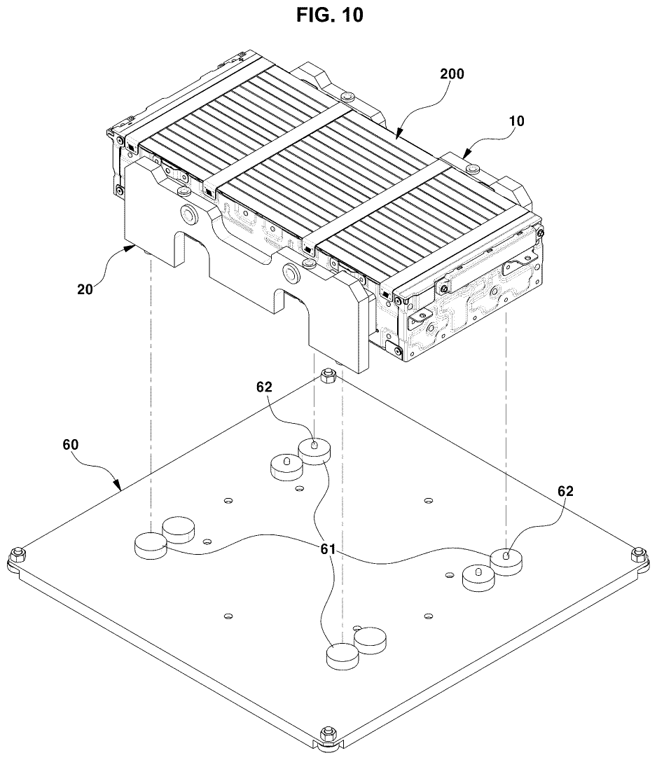

Accordingly, when the BMA 200 assembled as described above and the first adapter plate 10 and the second adapter plate 20 pressing the BMA 200 are placed on the base pallet 60 by a robot in a state where the base pallet 60 is placed on a transport conveyor (not shown) for transporting the BMA 200 to a post-assembly process, the BMA 200, the first adapter plate 10 and the second adapter plate 20 may be seated on the support protrusion 61 of the base pallet 60 as illustrated in FIG. 9, and the fixation pin 62 of the support protrusion 61 may be inserted into the bush 6 formed on the bottom surface of each of the first adapter plate 10 and the second adapter plate 20, allowing the first adapter plate 10 and the second adapter plate 20 to be placed and fixedly secured on the base pallet 60.

Therefore, after the BMA 200, and the first adapter plate 10 and the second adapter plate 20 pressing the BMA 200 are fixedly secured to the base pallet 60, the BMA 200, the first adapter plate 10 and the second adapter plate 20 may be easily transported to the post-assembly process along the transport conveyor.

Meanwhile, the plurality of support protrusions 61 may be formed on the upper surface portion of the base pallet 60 in an arrangement in which the first adapter plate 10 and the second adapter plate 20 of different sizes for assembling battery assemblies of different specifications may be seated on the plurality of support protrusions 61.

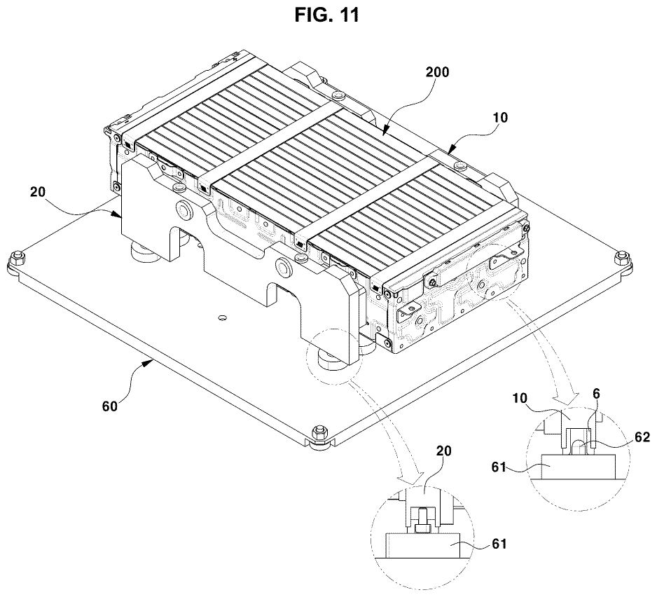

Accordingly, when the BMA 200 assembled in a larger size and the first adapter plate 10 and the second adapter plate 20 pressing the same are placed on the base pallet 60 by the robot, the fixation pins 62 of the support protrusions 61 formed, as illustrated in FIGS. 10 and 11, on outer sides among the support protrusions 61 of the base pallet 60 may be inserted into the bushes 6 formed on the bottom surfaces of the first adapter plate 10 and the second adapter plate 20, respectively, allowing easy transport to the post-assembly process along the transport conveyor.

As such, because the base pallet 60 is manufactured to have a structure on which BMAs of various sizes and the first adapter plate 10 and the second adapter plate 20 configured to press the same may be commonly mounted, the base pallet 60 may be commonly used when assembling various types of BMAs, reducing the number of assembly processes for the BMAs and reducing assembly costs.

As is apparent from the above description, the present disclosure provides the following effects.

First, battery cells may be fastened with a constant and even surface pressure, reducing the number of assembly processes and the cost of assembly compared to the spring-based assembly method of the related art.

Second, a BMA may be placed on a separate base pallet for common use, and then be easily transported to the post-assembly process along a transport conveyor.

Third, by manufacturing the base pallet in a structure that may commonly accommodate BMAs of various sizes, the base pallet may be commonly used when assembling various types of BMAs, reducing the number of assembly processes for BMAs and reducing assembly costs.

Although the present disclosure has been described in detail with reference to various embodiments, the scope of the present disclosure is not limited to the above-described embodiments, and various modifications and improvements by those skilled in the art based on the basic concept of the present disclosure as defined in the claims below will also be included in the scope of the present disclosure.

What is claimed is:

1. An apparatus for assembling a battery, the apparatus comprising:
a first adapter plate, wherein at least two guide shafts are mounted on the first adapter plate;
a second adapter plate, wherein a guide cylinder into which the guide shaft is inserted is mounted on the second adapter plate;
a biasing member fitted onto the guide shaft and configured to be engaged by the guide cylinder in response to the second adapter plate moving forward; and
an engagement member associated with the guide shaft.

2. The apparatus of claim 1, wherein the first adapter plate and the second adapter plate each have a structure in which a pair of pressure plates configured to press a plurality of battery cells stacked on one another is integrally connected to each other by a connection plate.

3. The apparatus of claim 2, wherein the pressure plate has an inner surface on which a pair of pressure blocks configured to press the stacked battery cells with a predetermined surface pressure is mounted by being brought into contact with each of opposite surfaces of the stacked battery cells.

4. The apparatus of claim 2, wherein the pressure plate has an inner surface on which a position limiting pin configured to restrict a position of the stacked battery cells is mounted by being brought into close contact with each of a first end plate and a second end plate stacked on opposite surfaces of the stacked battery cells, respectively.

5. The apparatus of claim 2, wherein a support block configured to support a bottom surface of the stacked battery cells is mounted at an outer position from a lower inner surface of the pressure plate.

6. The apparatus of claim 2, wherein a rigidity reinforcement bracket configured to reinforce a rigidity of each of the first adapter plate and the second adapter plate is mounted on an outer surface portion of the connection plate connected between the pair of pressure plates.

7. The apparatus of claim 6, wherein the rigidity reinforcement bracket has opposite end portions extending to the pair of pressure plates, respectively, to serve as a support for the engagement member.

8. The apparatus of claim 1, wherein the guide cylinder has an internal portion formed with a first hollow hole into which the guide shaft is inserted, and with a second hollow hole having a larger diameter than the first hollow hole to support the spring inserted into the second hollow hole.

9. The apparatus of claim 1, wherein the engagement member is a bolt, and the bolt is configured to be inserted into and fastened to the guide shaft.

10. The apparatus of claim 1, wherein a plurality of battery cells stacked on one another, and a first end plate and a second end plate brought into close contact with opposite sides of the stacked battery cells, respectively, are disposed in a pressing manner between the first adapter plate and the second adapter plate.

11. The apparatus of claim 1, wherein the biasing member is a spring.

12. The apparatus of claim 11, wherein, by a pressing motion in which the second adapter plate is moved forward in a state where the first adapter plate is fixed and a motion in which the engagement member is fastened into the guide shaft from the outer surface of the second adapter plate, a surface pressure to assemble the stacked battery cells, the first end plate and the second end plate into a battery module assembly is applied to the stacked battery cells, the first end plate and the second end plate.

13. The apparatus of claim 12, wherein the stacked battery cells, the first end plate and the second end plate are assembled into a battery module assembly by connecting a clamp or a fastening bolt into an assembly hole formed in each of the first end plate and the second end plate.

14. The apparatus of claim 1, further comprising a base pallet on which the first adapter plate and the second adapter plate are mounted to be transported for a post-process.

15. The apparatus of claim 14, wherein a plurality of support protrusions on which the first adapter plate and the second adapter plate are seated is formed on an upper surface portion of the base pallet, and a fixation pin is formed on an upper surface portion of some of the support protrusions.

16. The apparatus of claim 15, wherein a bush into which the fixation pin of the support protrusion is inserted is attached to a lower surface of each of the first adapter plate and the second adapter plate.

17. The apparatus of claim 15, wherein the plurality of support protrusions is formed on the upper surface portion of the base pallet in an arrangement in which the first adapter plate and the second adapter plate of different sizes for assembling battery assemblies of different specifications are seated.

18. The apparatus of claim 1, wherein the battery is mounted in a vehicle.

19. A method for assembling a battery, the method comprising:
mounting at least two guide shafts on a first adapter plate;
mounting a guide cylinder on a second adapter plate, and inserting a guide shaft into the guide cylinder;
engaging, by the guide cylinder, a biasing member fitted onto the guide shaft in response to the second adapter plate moving forward; and
providing an engagement member associated with the guide shaft.

20. The method of claim 19, further comprising fastening the engagement member into the guide shaft.
